(19) United States
(12) Patent Application Publication
(10) Pub. No.: US 2020/0300027 A1
(43) Pub. Date: Sep. 24, 2020

(54) AUTOMATED DOOR CONTROL SYSTEM AND CONVENIENCE FEATURES

(71) Applicant: Ford Global Technologies, LLC, Dearborn, MI (US)

(72) Inventors: Kristopher Karl Brown, Dearborn, MI (US); David Brian Glickman, Southfield, MI (US); Howard Paul Tsvi Linden, Southfield, MI (US); Larry Dean Elie, Ypsilanti, MI (US); Robert F. Novak, Farmington Hills, MI (US)

(73) Assignee: Ford Global Technologies, LLC, Dearborn, MI (US)

(21) Appl. No.: 16/536,763

(22) Filed: Aug. 9, 2019

Related U.S. Application Data
(60) Provisional application No. 62/821,636, filed on Mar. 21, 2019.

(51) Int. Cl. E05F 15/76; E05F 15/77; B60J 5/04; B60N 2/00

(52) U.S. Cl. CPC E05F 15/76; E05F 15/77; E05F 2015/767; B60N 2/002; B60J 5/047

(57) ABSTRACT

A power door system for a vehicle comprises an actuator configured to control a position of a door about a hinge assembly. The system further comprises a plurality of detection devices configured to detect an approaching passenger approaching the vehicle and a seated passenger within a passenger compartment of the vehicle. An angular position sensor is configured to identify an angular position of the door. A controller is configured to control the actuator to position the door in a first opened position in response to the detection of the approaching passenger and control the actuator to control the door to a second closed position in response to detecting the seated passenger in the passenger compartment.

### CROSS-REFERENCE TO RELATED APPLICATION

This application claims priority to U.S. Provisional Application No. 62/821,636 filed Mar. 21, 2019, entitled “AUTOMATED DOOR CONTROL SYSTEM AND CONVENIENCE FEATURES,” the entire disclosure of which is hereby incorporated by reference herein.

### FIELD OF THE DISCLOSURE

The present disclosure relates to vehicles, and more particularly to vehicles comprising vehicle door positioning systems.

### BACKGROUND OF THE DISCLOSURE

In an effort to improve vehicle operation and convenience, many manufacturers have introduced a variety of convenience and operating features to vehicles. However, many components and systems of vehicles remain significantly similar to conventional vehicle designs dating back to the previous century. The disclosure provides for various systems and apparatuses to provide for improved operation of at least one door of a vehicle. The systems discussed herein may include doors that either assist a user when accessing the vehicle and/or are configured to open and close without requiring a vehicle user to physically reposition the door. Such systems may provide for improved operation of a vehicle as described herein.

### SUMMARY OF THE DISCLOSURE

According to one aspect of the present disclosure, a power door system for a vehicle comprises an actuator configured to control the position of a door about a hinge assembly. The system further comprises a plurality of detection devices configured to detect a passenger approaching the vehicle and a seated passenger within a passenger compartment of the vehicle. An angular position sensor is configured to identify an angular position of the door. A controller is configured to control the actuator to position the door in a first opened position in response to the detection of the approaching passenger and control the actuator to control the door to a second closed position in response to detecting the seated passenger in the passenger compartment.

Embodiments of the disclosure can include any one or a combination of the following features:
the door is oriented at a first angle in the first opened position and a second angle in the second opened position, wherein the second opened position is less than the first opened position;
the second angle is configured to position the door such that a handle of the door is within a predetermined distance of the passenger compartment of the vehicle;
the predetermined distance is a reach distance measured from a passenger seat of the vehicle to the handle of the door;
the first opened position comprises the angular position of the door at an angle greater than or equal to 70 degrees;
the second opened position comprises the angular position of the door at an angle less than 70 degrees;
the plurality of detection devices comprises at least one imager or camera and a seat sensor;
the controller is further configured to identify the approaching passenger based on image data captured by the imager;
the controller is further configured to identify the seated passenger within the passenger compartment of the vehicle in response to a signal from the seat sensor;
the plurality of detection devices comprises a communication circuit configured to detect an approximate location of a mobile device via a communication signal;
the mobile device comprises at least one of a smartphone, a key fob, and a personal identification device; and/or
the communication signal is communicated via a Bluetooth® low energy (BLE) communication protocol.

According to another aspect of the present disclosure, a method for controlling a power door system for a vehicle is disclosed. The method comprises identifying an approaching passenger and opening a door of the vehicle via an actuator to a first position in response to the detection of the approaching passenger. The method further comprises detecting the approaching passenger in a passenger compartment of the vehicle as a seated passenger and positioning the door of the vehicle at a second position in response to the detection of the seated passenger. The method may further await a manual interaction with the door in the second angular position.

Embodiments of the disclosure can include any one or a combination of the following features or steps:
identifying the approaching passenger based on image data captured by an imager;
identifying the seated passenger within the passenger compartment of the vehicle in response to a signal from a seat sensor of the vehicle;
the door is positioned at a first angle in the first position and a second angle in the second position and the second angle is less than the first angle;
the first angle and the second angle are greater than 30 degrees; and/or
monitoring an acceleration rate of the door when opening and/or closing the door and controlling the actuator to stop a motion of the door in response to the acceleration exceeding a predetermined threshold.

According to another aspect of the present disclosure, a power door system for a vehicle is disclosed. The system comprises an actuator configured to control the position of a door about a hinge assembly and a plurality of detection devices. The plurality of detection devices comprises at least one imager and a seat sensor. The imager is configured to detect an approaching passenger of the vehicle and the seat sensor is configured to detect a seated passenger within a passenger compartment of the vehicle. The system comprises an angular position sensor configured to identify an angular position of the door and a controller. The controller is configured to identify the approaching passenger based on image data captured by the at least one imager and control the actuator to position the door in a first opened position in response to the detection of the approaching passenger. The controller is further configured to identify the seated passenger within the passenger compartment of the vehicle in response to a signal from the seat sensor and control the actuator to control the door to a second opened position in response to detecting the seated passenger in the passenger compartment. In some aspects, the controller may further be configured to detect the seated passenger reaching for the door based on the image data from the at least one imager and control the actuator to position the door in the second position in response to the detection of the seated passenger in combination with the detection of the seated passenger reaching toward the door.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a projected view of a person approaching a vehicle comprising a power door system;

FIG. 2 is a projected view of a passenger interacting with a door control system of a vehicle;

FIG. 3 is a plan view of a person approaching a vehicle demonstrating a plurality of fields of view of imaging sensors;

FIG. 4 is a flowchart demonstrating a plurality of operating methods for a door control system;

FIG. 5 is a top schematic view demonstrating a vehicle comprising a door control system;

FIG. 6A is a flowchart demonstrating a door opening routine of the door control system;

FIG. 6B is a flowchart demonstrating a door closing routine of the door control system;

FIG. 7 is a flowchart demonstrating a method for an automated operation of a door control system;

FIG. 8 is schematic diagram of an operating routine for a door control system;

FIG. 9 is schematic diagram of an operating routine for a door control system; and

FIG. 10 is a flowchart demonstrating a method for controlling a door control system in accordance with the disclosure.

### DETAILED DESCRIPTION OF THE PREFERRED EMBODIMENTS

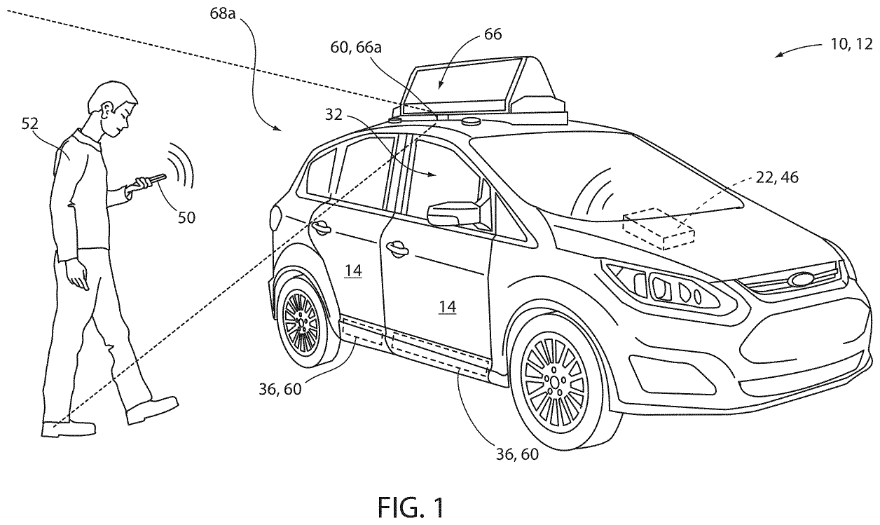

For purposes of description herein, the terms “upper,” “lower,” “right,” “left,” “rear,” “front,” “vertical,” “horizontal,” “interior,” “exterior,” and derivatives thereof shall relate to the device as oriented in FIG. 1. However, it is to be understood that the device may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature or component extending in or along a given direction, or the like, does not mean that the feature or component follows a straight line or axis in such a direction or that it only extends in such direction or on such a plane without other directional components or deviations, unless otherwise specified.

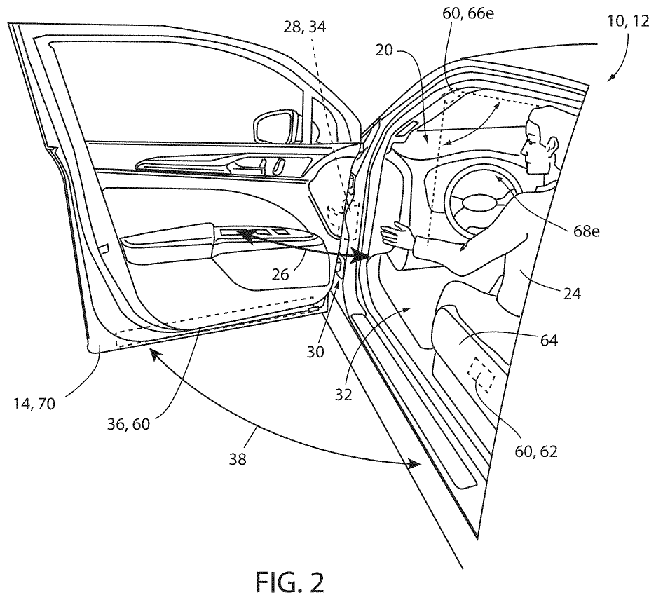

With specific reference to FIGS. 1-2, a vehicle 10 comprising a power door system 12 is shown. As shown, the vehicle 10 includes a door opening 20, with the doors 14 mounted adjacent door openings 20 in a body of the vehicle 10. The door 14 is moveable relative to the door opening 20 between a closed position and a range of open positions. The vehicle 10 also includes a controller 22 that determines whether an instantaneous door position is in a closed position or is within the range of open positions. In various embodiments, the controller 22 of the power door system 12 may be configured to control an angular position ϕ of the door 14.

In exemplary embodiments, the control of the angular position ϕ of the door 14 may vary from 0-85 degrees or more. In conventional vehicle doors, the operating range may be limited to an angular range from approximately 0-68 degrees. Accordingly, the operation of the door system 12 as discussed herein, may result in the doors 14 of the vehicle 10 extending outward away from the door openings 20 such that a passenger 24 is unable to reach the door 14 to control the motion of the door 14. For clarity, an excess reach distance 26 outside the reach of the passenger 24 is represented by an arrow. The excess reach distance 26 demonstrates the resulting space between the passenger 24 and the door 14 when the door 14 is in a fully opened position. Accordingly, as demonstrated, manual or assisted positioning of the doors 14 may be impossible without exiting the vehicle 10. The disclosure provides for a variety of control schemes and operating methods configured to control the power door system 12 to adjust the angular position ϕ of the door 14 easily and intuitively.

An actuator 28 is in communication with a controller 22 (shown in FIG. 2) configured to detect and control the angular position ϕ of the door 14. In some implementations, the actuator 28 may be a power assist device that is disposed adjacent to the door 14 and is operably and structurally coupled to the door 14 for assisting in moving the door 14 between open and closed positions, as further described below. As illustrated, the actuator 28 is coupled to the door 14 and is operably coupled to the hinge assembly 30 for powering the movement of the door 14 between the open and closed positions. In various implementations, the actuator 28 can provide access to a passenger compartment 32 of the vehicle 10 for passenger ingress or egress. The actuator 28 may include a motor, which may be in the form of an electric motor, hydraulic actuator, power winch, slider mechanism or other actuator mechanism having sufficient power necessary to provide the torque required to move the door 14 between open and closed positions, as well as various detent locations. Thus, the motor may be configured to act on the door 14 at or near the hinge assembly 30 in a pivoting or rotating manner.

The controller 22 may comprise a motor control unit comprising a feedback control system configured to accurately position the door 14 about the hinge assembly 30 in a smooth and controlled motion path. The controller 22 may further be in communication with a door position sensor 34 as well as at least one interference sensor 36. The door position sensor 34 may be configured to identify the angular position of the door 14 and the interference sensor 36 may be configured to identify a potential obstruction located along a swing path 38 of the door 14. Further, the interference sensor 36 may be included in a system used to detect and calculate the number of passengers occupying an autonomous taxi, ride share, or various for-hire vehicles, as discussed herein.

The actuator 28 may be configured to adjust the door 14 from an opened position to a closed position and control the angular position 4 of the door 14 therebetween. The actuator 28 may be any type of actuator that is capable of transitioning the door 14 about the hinge assembly 30, including, but not limited to, electric motors, servo motors, electric solenoids, pneumatic cylinders, hydraulic cylinders, etc. The actuator 28 may be connected to the door 14 by gears (e.g., pinion gears, racks, bevel gears, sector gears, etc.), levers, pulleys, or other mechanical linkages. The actuator 28 may also act as a brake by applying a force or torque to prevent the transitioning of the door 14 between the opened position and the closed position. The actuator 28 may include a friction brake to prevent the transition of the door 14 about the hinge assembly 30.

The position sensor 34 may correspond to a variety of rotational or position sensing devices. In some embodiments, the position sensor 34 may correspond to an angular position sensor configured to communicate the angular position 4 of the door 14 to the controller 22. The angular position 4, may be utilized by the controller to control the motion of the actuator 28. The door position sensor 34 may correspond to an absolute and/or relative position sensor. Such sensors may include, but are not limited to, quadrature encoders, potentiometers, accelerometers, Amorphous, Magneto Resistive (AMR sensors), etc. The position sensor 34 may also correspond to optical and/or magnetic rotational sensors. Other sensing devices may also be utilized for the position sensor 34 without departing from the spirit of the disclosure.

In some examples, one or more of the doors 14 of the vehicle 10 may be configured as sliding doors. As discussed herein, a sliding door may be configured to open along a translational path relative to an opening providing access to the passenger compartment 32 of the vehicle 10. Accordingly, the actuator 28 as discussed herein may be configured to control a translation of the doors 14 in a sliding configuration to accommodate various methods and control operations of the doors 14 as discussed herein. Accordingly, the disclosure may be flexibly implemented to suit various door systems without departing from the spirit of the disclosure.

The interference sensor 36 may be implemented by a variety of devices, and, in some implementations, may be utilized in combination with the actuator 28 and the position sensor 34 to detect and control the motion of the door 14. The interference sensor 36 may correspond to one or more capacitive, magnetic, inductive, optical/photoelectric, laser, acoustic/sonic, radar-based, Doppler-based, thermal, and/or radiation-based proximity sensors. In some embodiments, the interference sensor 36 may correspond to an array of infrared (IR) proximity sensors configured to emit a beam of IR light and compute a distance to an object in an interference zone corresponding to the swing path 38 based on characteristics of a returned, reflected, or blocked signal. The returned signal may be detected using an IR photodiode to detect reflected light emitting diode (LED) light, responding to modulated IR signals, and/or triangulation.

In some embodiments, the interference sensor 36 may be implemented as a current sensor configured to detect a current or power draw of the actuator 28. For example, the interference sensor 36 may be utilized to monitor the power delivered to the actuator 28 throughout the maneuvering of the door 14. In response to an increase in the current draw of the actuator 28 exceeding a predetermined threshold, the controller 22 may be configured to detect an obstruction or an object impeding the operation of the actuator 28. In response to the detection of an obstruction, the controller 22 identifies that the door 14 has reached an available travel extent and stops the motion of the door 14 by controlling the actuator 28. In this way, the interference sensor may be provided as a sensor configured to monitor the operation of the actuator 28.

In some embodiments, the interference sensor 36 may be implemented as a plurality of sensors or an array of sensors configured to detect an object or obstruction in the interference zone which may include regions within the swing path 38 of the door 14. Such regions may be both inside the swing path 38 between the door 14 and the body of the vehicle 10 as well as outside the door 14, away from the body of the vehicle 10. Such sensors may include, but are not limited to, touch sensors, surface/housing capacitive sensors, inductive sensors, video sensors (such as a camera), light field sensors, etc.

Still referring to FIGS. 1 and 2, in some implementations, the controller 22 may comprise a communication circuit 46. The communication circuit 46 may correspond to a wireless receiver and/or transmitter configured to communicate with a mobile device 50. In this configuration, the controller 22 may receive various communications from the mobile device 50 requesting access to or otherwise communicating with the vehicle 10. In some embodiments, the mobile device 50 may be configured to communicate security access information to the controller 22 to authenticate or verify that a nearby or approaching person 52 is authorized to enter the vehicle 10. In response to receiving the security access information from the mobile device 50, the controller 22 may be configured to control the door actuators 28 and/or additional vehicle systems (e.g. door locks, etc.) to allow the person 52 (FIG. 1) to enter the vehicle 10 as an authorized passenger 24 (FIG. 2). In this configuration, the controller 22 may provide for secure operation of the vehicle 10.

The communication circuit 46 may correspond to one or more circuits that may be configured to communicate via a variety of communication methods or protocols. In an exemplary embodiment, the communication circuit 46 may be configured to detect a direction vector of signals communicated to and/or from the mobile device 50 in order to determine a location of the mobile device 50 relative to the vehicle 10 or within the passenger compartment. Such operation may be accomplished via a beacon detection of the mobile device 50 that may be processed via an angulation and proximity detection of the signals communicated between the communication circuit 46 and the mobile device 50, which may be accomplished via an antenna array in communication with the communication circuit 46. In this way, the system 12 may be configured to detect an approximate position of the person 52 near the vehicle 10 and/or the location of the passenger 24 within the vehicle 10 by tracking the location of the mobile device 50 or beacon. As discussed herein, the mobile device 50 may correspond to a smartphone, a key fob, a personal identification device (e.g. a radio identification tag) and/or any device that may accompany an occupant of the vehicle 10 and indicate an identity of authorization to access the vehicle 10.

In various implementations, the communication circuit 46 may be configured to communicate in accordance with one or more standards including, but not limited to, 3GPP, LTE, LTE Advanced, IEEE 802.11, Bluetooth®, advanced mobile phone services (AMPS), digital AMPS, global system for mobile communications (GSM), code division multiple access (CDMA), local multi-point distribution systems (LMDS), multi-channel-multi-point distribution systems (MMDS), radio frequency identification (RFID), Enhanced Data rates for GSM Evolution (EDGE), General Packet Radio Service (GPRS), and/or variations thereof. Additional protocols may include short-range communication protocols including, but not limited to, RFID, Bluetooth®™, Bluetooth® Low Energy (BTLE), ANT+, NFC, ZigBee, infrared, ultraband, etc. In general, a short-range communication protocol, as discussed herein, may correspond to a communication method that has a typical range of less than 1 km and may correspond to a communication method having a range of less than 100 m.

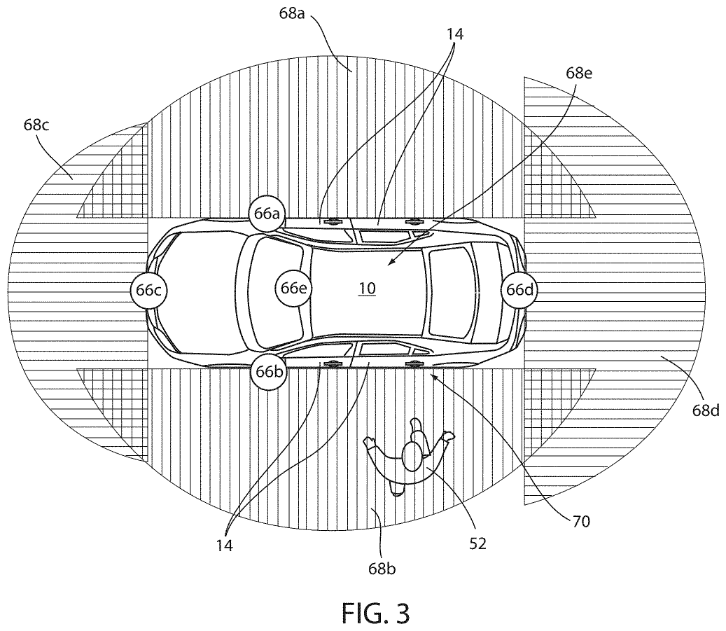

Referring now to FIGS. 2 and 3, in general, the door control system 12 may comprise a plurality of occupant detection devices 60 comprising the communication circuit 46 configured to locate the mobile device 50, the interference sensor 36, and various additional devices as discussed herein. In some implementations the detection devices 60 may comprise a plurality of seat sensors 62, which may include pressure or weight sensors disposed in each of a plurality of vehicle seats 64. In addition to or similar to the seat sensors 62, the system 12 may also monitor one or more seatbelt sensors to monitor the occupancy of each of the seats 64 or anticipate changes in the occupancy of the passenger compartment 32. Accordingly, the system 12 may monitor various detection devices 60 to identify or infer changes in the occupancy of the vehicle 10.

In some implementations, the detection devices 60 may further comprise an imaging system 66 comprising one more imagers 66a, 66b, 66c, 66d, 66e, etc. Each of the imagers 66a, 66b, 66c, 66d, and 66e may be configured to capture image data in a corresponding field of view 68a, 68b, 68c, 68d, and 68e. Each field of view 68 may be configured to capture image data in a variety of portions of the passenger compartment 32 and regions proximate to the vehicle 10. In this way, the door control system 12 may be configured to control the angular position ϕ of each of the doors 14, based on a position of the passenger 24 and/or an approaching person 52 by detecting their relative location relative to the vehicle 10. Similarly, the control system 12 may be configured to detect one or more gestures (e.g. the passenger reaching for the door 14) and/or a direction of a gaze of the passenger 24 or person 52 relative to the vehicle 10. Accordingly, the door control system 12 may be configured to detect a location and/or behavior of the passenger 24 or approaching person 52 and independently control each of the doors 14 to respond to the location and/or behavior as further discussed herein.

In operation, the control system 12 may be configured to process the image data from each of the imagers 66a-66e. As illustrated in FIG. 3, imager 66a-66d may correspond to exterior imagers configured to capture image data in the fields of view 68a-68d distributed about an exterior perimeter of the vehicle 10. Imager 66e may be configured to capture image data in a field of view 68e focused on the passenger compartment 32 of the vehicle 10. In this way, the system 12 may be configured to identify a location of the passenger 24 within the vehicle 10 and/or identify a location of the person 52 relative to the vehicle 10. Based on the location of the passenger 24 and/or the person 52, the system 12 may identify a seat 64 in which the passenger 24 is seated. Similarly, the system 12 may process the image data to identify an entry door 70 that corresponds to or opens to a vacant seat 64 in the vehicle 10 for the person 52 to enter the vehicle 10. In addition to the image data, the system 12 may additionally process data from each of the seat sensors 62 disposed in each of the plurality of vehicle seats 64 to identify an occupancy and location of each of the passengers 24 in the passenger compartment 32.

In general, the occupant detection device or devices 60 may comprise any form of data acquisition device or any combination of sensory devices that may be in communication with the controller 22. The detection device 60 may correspond to a device configured to capture image data, for example an imager, video camera, infrared imager, scanner, or any device configured to capture text, graphics images, and/or video data. In some embodiments, the detection device 60 may correspond to a device configured to capture voice or any form of audio data, for example a microphone, audio decoder, and/or an audio receiver. The detection device 60 may also correspond to a capacitive, image-based, and/or pressure-based sensor configured to scan a finger print. An image sensor may be configured to identify a facial feature, height, profile shape, gaze direction, head position, or any other form of visual data. In this way, the control system 12 may be configured to utilize information captured by the detection devices 60 to identify the location and/or behavior of the passenger 24 or person 52 approaching the vehicle 10.

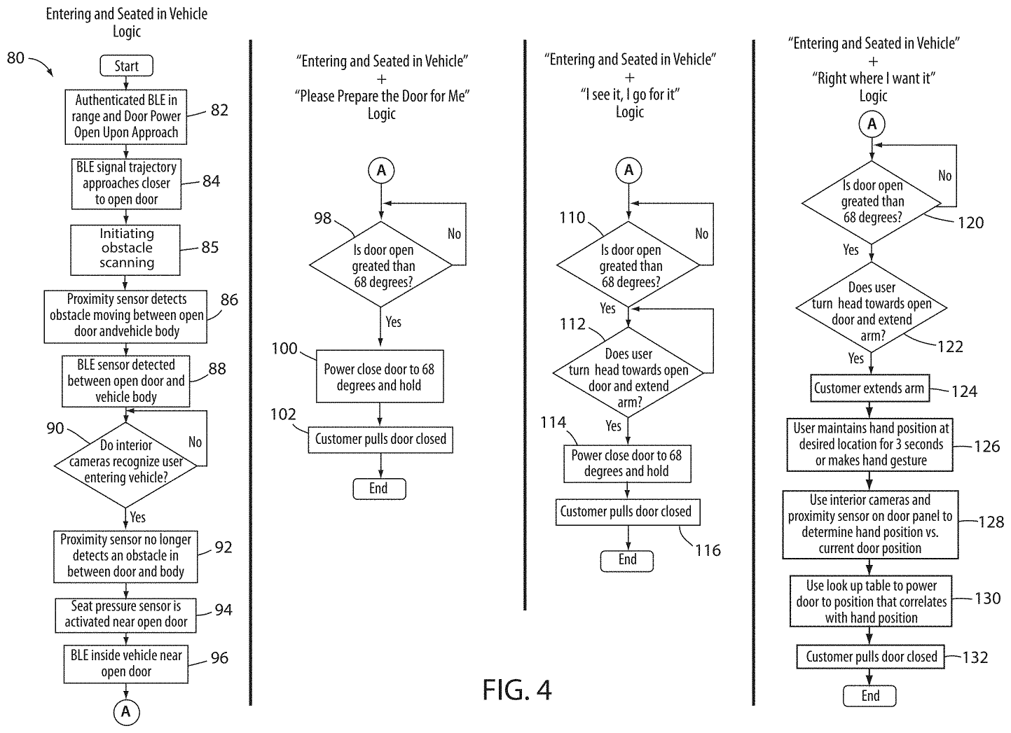

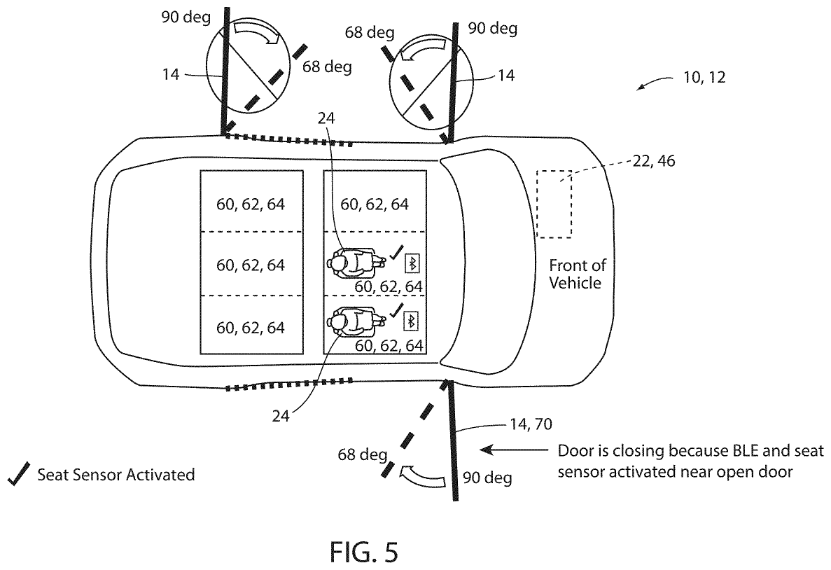

Referring now to FIG. 4, a flowchart is shown demonstrating an exemplary operating method 80 of the door system 12. The operation of the method 80 is described in reference to a simplified schematic diagram of the vehicle 10 shown in FIG. 5 for clarity. The method may begin in step 82 by authenticating a security signal communicated from the mobile device 50 (e.g. a BLE signal) and opening a door 14 corresponding to a location of the person 52 upon approach. In this way, the system 12 may detect a signal trajectory of the mobile device 50 to identify the entry door 70 for the person 52 to enter the vehicle 10 as an authenticated passenger 24 (84). Following the authentication, the system 12 may activate the interference sensor 36 to initiate obstruction detection (85). Once the passenger 24 reaches a detection range of the interference sensor 36, the interference sensor 36 may detect the person as an obstacle moving between the entry door 70 and the body of the vehicle (86). Additionally, in step 88, the signal from the mobile device 50 (e.g. BLE signal) may also be detected between the entry door 70 and the body of the vehicle 10.

Following step 88, the system 12 may process the image data from the imaging system 66 (interior imager 66e) to identify if the person 52 has entered the vehicle (90). The method 80 may continue to scan the image data in step 90 until the person 52 is recognized as having entered the passenger compartment 32. Once the person 52 is recognized as entering the passenger compartment 32, the method 80 may process the data from the interference sensor 36 to determine if an obstacle (e.g. the person 52) is located between the entry door 70 and the body of the vehicle 10 (92). Additionally, the system 12 may monitor each of the seat sensors 62 of the seats 64 to identify if the person 52 is seated in one of the seats 64, which may correspond to a seat 64 adjacent to the entry door 70 (94). Finally, the system 12 may further verify that the person 52 is located in the passenger compartment 32 based on the signal from the mobile device 50 being located within the passenger compartment 32 (96).

Once the person 52 has entered the vehicle 10 and is identified as the passenger 24, the system 12 may control a closing operation of the entry door 70 in a variety of ways. Accordingly, following step 96, the method 80 may continue to step 98 to identify whether the entry door 70 is open at an angular position Q greater than 68 degrees. If the entry door 70 is opened at an angular position ϕ greater than 68 degrees, the system 12 may control the actuator 28 of the entry door 70 to power close the door 70 to the angular position ϕ of 68 degrees (100). Once the entry door 70 is positioned at the angular position ϕ of 68 degrees, the passenger 24 may manually pull the entry door 70 to a closed position and the method 80 may conclude (102).

In some implementations, following the determination that the person 52 has entered the passenger compartment 32 in step 96, the method 80 may continue to step 110 to identify if the entry door 70 is opened to the angular position ϕ greater than 68 degrees. If the entry door 70 is opened to the angular position ϕ greater than 68 degrees, the system 12 may further determine if the passenger 24 turns his or her head toward the entry door 70 and extends an arm based on the image data captured in the interior field of view 68e (112). An example of such a gesture that may be identified by the system 12 is shown in FIG. 2. In response to identifying that the passenger 24 has turned his or head toward the entry door 70 and extended an arm, the system 12 may control the angular position ϕ of the entry door 70 to close to approximately 68 degrees and hold the position of the entry door 70 (114). Following the positioning of the entry door 70 to 68 degrees, the passenger 24 may manually pull the entry door 70 closed and the method may conclude (116).

In yet another operating configuration, following the detection of the passenger 24 and the passenger compartment 32 in step 96, the method 80 may continue to identify if the angular position ϕ of the door 14 is greater than 68 degrees (120). If the angular position ϕ of the entry door 70 is greater than 68 degrees, the system 12 may monitor the image data from the field of view 68e to determine if the passenger 24 turns his or her head toward the entry door 70 and extends an arm as previously discussed in reference to step 112 (122). Following step 122, the system may identify that the passenger 24 extends the arm toward the entry door 70 (124). The system 12 may then continue to monitor the image data to determine if the position of the arm of the passenger 24 extended toward the entry door 70 for a predetermined period of time (e.g. 3 seconds) and/or a motion of a hand or the arm is detected forming a gesture (126). Following step 126, the system 12 may continue to monitor the field of view 68e and the interference sensor 36 to determine the position of the hand or arm of the passenger 24 in relation to the angular position ϕ of the entry door 70 (128).

Based on the position of the hand or arm of the passenger 24 relative to the angular position ϕ of the entry door 70, the system 12 may control the actuator 28 to control the angular position of the door 14 based on a predetermined configuration (130). The predetermined configuration may be based on the detected extent of a hand or portion of the passenger 24 relative to the entry door 70. In some implementations, the controller 22 may determine an angular position ϕ of the entry door 70 based on a calculation relative to a location of the portion of the passenger 24 identified in the image data captured by the imaging system 66 and/or based on a proximity or positional identification by the interference sensor 36. Accordingly, the angular position ϕ of the entry door 70 may be identified or calculated by the controller 22 of the system 12 based on a lookup table or positioning algorithm stored in memory and configured to identify a predetermined angular position ϕ of the entry door 70 relative to a portion of the passenger 24.

Accordingly, in step 130, based on the detected position of a portion of the passenger 24 extending nearest to the entry door 70 in the swing path 38, the controller 22 may identify or calculate the angular position ϕ of the entry door 70 such that the entry door 70 may be positioned at the angular position ϕ nearby, proximate to, or at the fingertips of the passenger 24. In such implementations, the entry door 70 may be positioned at the angular position ϕ corresponding or commensurate to the reach or position of the portion of the passenger 24 such that the excess reach distance 26 is minimized or approximately zero. In such implementations, the entry door 70 may be positioned and held by the actuator 28 at a variety of angular positions ϕ as determined based on the detected portion of the passenger 24. Finally, in step 132, once the entry door 70 is closed to a position where the angular position ϕ of the entry door 70 meets or is close to the identified position of the portion of the passenger. In this way, the system 12 may control the angular position ϕ of the entry door 70 to a position proximate to a hand or portion of the passenger such that the passenger may manually pull the entry door 70 to a closed position and the method may conclude.

As discussed in reference to step 130, the controller 22 may be configured to control a rate of motion and corresponding rate of change of the angular position ϕ of the entry door 70. In some embodiments, the controller 22 may be configured to slow the rate of change of the angular position ϕ such that the door gradually stops when reaching a target angular position ϕ, which may be identified based on the image data captured by the imaging system 66 and/or proximity of position data identifying a location of the passenger as communicated from the interference sensor 36. In this configuration, controller 22 may be configured to control the rate of change of the angular position ϕ at a variable deceleration rate or constant deceleration rate such that the actuator 28 is controlled to decrease the rate of change of the angular position ϕ as the entry door 70 approaches the portion of the passenger 24.

Additionally, in some implementations, the system 12 may be configured to stop the door proximate to the portion of the passenger 24 extending nearest to the entry door 70 in the swing path 38 while maintaining a buffer or gap between the passenger 24 and the entry door 70. For example, based on the lookup table or the algorithm configured to determine the angular position ϕ of the entry door 70 in step 130, the system 12 may provide for entry door 70 to be positioned such that a portion of the reach distance 26 may be maintained between the passenger 24 and the entry door 70. In this configuration, the controller may be configured to position the door near the passenger 24 in step 130 while maintaining the buffer between the passenger 24 and the door 70.

Finally, in addition to the control elements discussed in reference to step 130, the system 12 may monitor the position of the passenger 24 to identify a change in the reach distance 26 during the control of the angular position ϕ of the entry door 70. Accordingly, if the position of the portion (e.g. hand, arm, leg, foot, etc.) of the passenger 24 changes during the positioning or adjustment of the angular position ϕ of the entry door 70 by the controller 24, the system may update the position and adjust the angular position ϕ of the entry door 70 based on the updated position. The update of the position of the portion of the passenger 24 may be identified based on the image data captured by the imaging system 66 and/or proximity of position data identifying the location of the passenger as communicated from the interference sensor 36. Additionally, in some embodiments, the location of the mobile device 50 may additionally be utilized as a factor to determine wherein the passenger 24 is located relative to the entry door 70, the passenger compartment 32, the doors 14, and various portions of the vehicle 10.

Though discussed in reference to FIG. 4 as an angular position ϕ of approximately 68 degrees, the system 12 may be configured to locate the angular position ϕ of the entry door 70 or any one of the doors 14 of the vehicle 10 at a desired or predetermined angular position 4. The specific angle of 68 degrees is described herein because it corresponds to a conventional standard for the angular position ϕ of the doors 14 that may be accessible or reachable by one or more of the passengers 24 in vehicle 10. However, the angular position ϕ of each of the doors 14 may vary based on a desired orientation or user preference without departing from the spirit of the disclosure. In general, the angular position ϕ of the doors 14 discussed herein may be referred to as closed (e.g. ϕ=0 degrees), fully opened (e.g. ϕ>68 degrees), and partially opened (e.g. ϕ<68 degrees), where the angular position ϕ of the doors 14 being less than 68 degrees may be considered within the reach of the passenger 24. Accordingly, the system 12 may be flexibly configured to suit a variety of applications.

Though the angular position ϕ of the doors 14 is referred to in reference to the angle, 68 degrees, the angle may vary based on the particular application of the system 12 and the dimensions of the vehicle 10. For example, the angular value boundary separating the fully opened versus the partially opened angular position ϕ of the doors 14 may vary based on the dimension of the vehicle 10 and the corresponding reach distance 26. For example, the angular position ϕ or orientation of the doors 14 that may be at the extent of the reach distance 26 or comfortable extent of the reach of a passenger when seated in the vehicle 10 may be set to a value that may vary from approximately 60-75 degrees, 65-75 degrees, 66-72 degrees, etc. based on the dimensions of the vehicle 10 and the relationship of the position of a passenger when seated in the vehicle 10.

Additionally, in some implementations, the angular position ϕ where the doors 14 is adjusted to the partially opened orientation may be programmed based on a user preference or profile that may differ for different operators of the vehicle. For example, the angle corresponding to the partially opened orientation may be programmed based on an identification a passenger or operator of the vehicle 10 as determined based on an input to a user interface of the vehicle, a communication from the mobile device 50, and/or a communication from a fey fob configured to indicate an identity or user profile of the vehicle 10. Accordingly, the disclosure may provide for the angular value boundary (e.g. 68 degrees) separating the fully opened versus the partially opened angular position ϕ of the doors 14 to vary or be adjusted to suit a desired application.

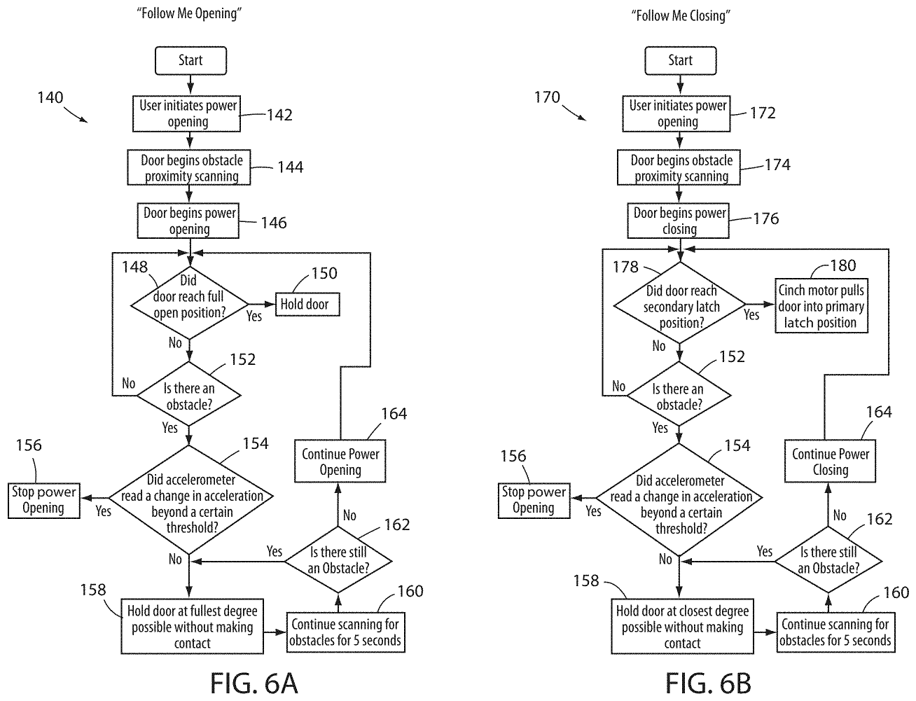

Referring now to FIGS. 6A and 6B, flowcharts demonstrate a method 140 for opening and closing each of the doors 14 via the door control system 12. The method 140 may begin in FIG. 6A in response to a person 52 initiating a power opening routine (142). The power opening routine of the door control system 12 may be activated via the mobile device 50, a voice command, and/or an inner/outer action of the person 52 with a handle, switch, touchscreen display, or sensor configured to activate the power opening of a selected one of the doors 14. Following the initiation in step 142, the controller 22 may scan proximity or detection data captured by the interference sensor 36 to detect one or more obstacles that may be located in the swing path 38 of the selected one of the doors 14 (144). If the swing path 38 is determined to be free of obstacles, the controller 22 may control a power-opening procedure of the selected one of the doors 14 (146). As discussed herein, obstacles may include various objects including persons or portions of persons (e.g. hands, feet, legs, etc.), and/or various objects that may interfere with or obstruct the swing path 38. During the power-opening procedure, the controller 22 may monitor the angular position ϕ of the door 14 to determine if the door 14 has reached a fully open position (e.g. an angular position ϕ of 70-120 degrees) (148). If the door 14 has reached a fully open position as detected in step 148, the controller 22 may hold the angular position ϕ of the door 14 in step 150. Throughout step 148, the system may continue to monitor the interference sensor 36 to detect one or more obstacles in the swing path 38 of the door 14 (152). If an obstacle is not detected in step 152, the method may continue to step 150 and hold the door 14 at the fully open position. However, if an obstacle is detected in step 152, the method may continue to step 154. As previously discussed, the interference sensor 36 may correspond to a variety of sensory devices including but not limited to a current sensor configured to monitor the current draw of the actuator 28, one or more capacitive, magnetic, inductive, optical/photoelectric, laser, acoustic/sonic, radar-based, Doppler-based, thermal, radiation-based proximity sensors, etc.

In step 154, an inertial sensor or accelerometer of the door 14 may be monitored by the controller 22 to determine if an acceleration of the door 14 has exceeded a predetermined acceleration threshold. If the acceleration threshold is detected as being exceeded in step 154, the method may continue to step 156 and stop opening the door 14. If the acceleration threshold is not exceeded in step 154, the method may continue to maneuver the door 14 toward the obstacle detected in step 152 and hold the door 14 at the furthest angular position ϕ possible without causing the door 14 to contact the obstacle (158). Following step 158, the door 14 may be held and the system 12 may continue to scan the data from the interference sensor 36 for obstacles at predetermined time intervals (e.g. 5 seconds) (160). In step 162, the controller 22 may determine if the obstacle detected in step 152 is still located in the swing path 38. If the obstacle is still located in the swing path 38, the method 140 may continue to step 158. If the obstacle is no longer detected in step 162, the controller 22 may continue the power-opening operation in step 164 and return to step 148.

Referring now FIG. 6B, a door-closing procedure for the vehicle may be processed similarly to the door-opening procedure described in reference to FIG. 6A. Accordingly, the steps of FIG. 6B for the closing operation may only be discussed in reference to the differences from the opening procedure described in reference to FIG. 6A. Similar to step 142, in step 172, passenger 24 may initiate a closing routine of the entry door 70. In steps 174 and 176, the door control system 12 may continue by scanning the data from the interference sensor 36 to identify obstacles and further may control the entry door 70 to begin a closing operation. In step 178, the door control system 12 may monitor the angular position ϕ of the entry door 70 to determine if the entry door 70 has reached a secondary latched position. If the secondary latched position is reached in step 178, the method 140 may continue to activate a cinch motor to pull the entry door 70 into a primary latch or closed position (180). If the door 14 does not reach the secondary latched position, the method 140 may continue as described in reference to steps 152-164 while attempting to close the entry door 70 or maneuver the door 14 to a closed position rather than the opened position as described in reference to FIG. 6A. Accordingly, the same reference numerals are utilized in steps 152-164 in FIGS. 6A and 6B to demonstrate similar steps.

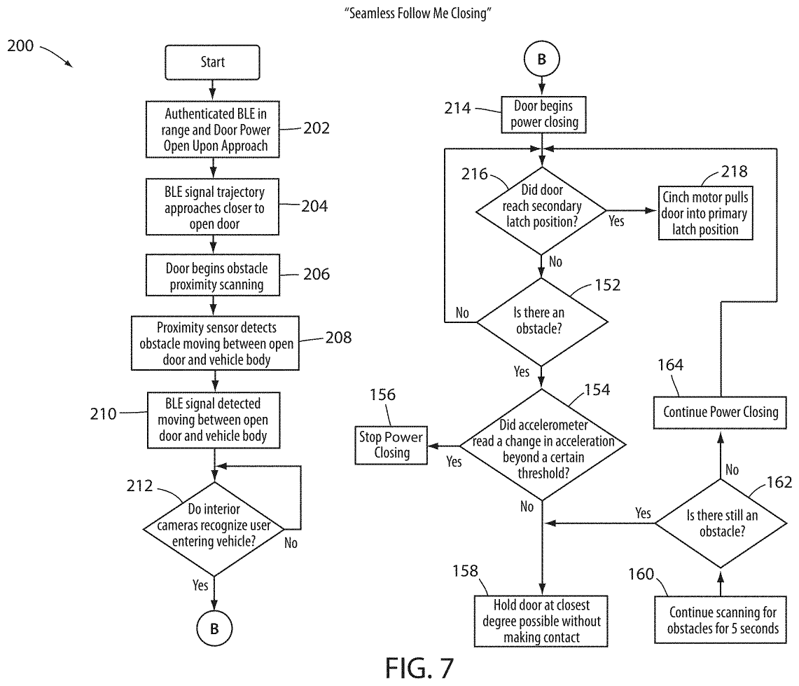

Referring now to FIG. 7, in some embodiments, the door control system 12 may be configured to operate in response to the approach of the person 52 without any overt actions by the person 52 required for activation of the system 12. Accordingly, the method 200 demonstrated in FIG. 7, may begin by detecting a security signal communicated by the mobile device 50 (e.g. a BLE signal) and controlling the entry door 70 to open (202). As previously discussed, the entry door 70 selected from the doors 14 may be identified based on a signal trajectory of the mobile device 50 and/or a detection of the person 52 approaching the vehicle identified in the imaging data captured by the imaging system 66 (204). Following step 204, once the controller 22 begins moving the entry door 70, the controller 22 may monitor signals from the interference sensor 36 to identify one or more obstacles located in the swing path 38 (206). During the scanning operation of the interference sensor 36, the controller 22 may detect an obstacle (e.g. the person 52) moving between the entry door 70 oriented with the angular position ϕ in an opened configuration and the body of the vehicle 10 (208). Additionally, the controller 22 may be configured to detect the signal from the mobile device 50 moving between the entry door 70 and the body of the vehicle 10 (210). Upon detecting the obstacle or the signal from the mobile device 50 in steps 208 and/or 210, the system 12 may scan image data captured in the interior field of view 68e of the imaging system 66 to determine if the passenger 24 has entered the vehicle 10 (212). Though not shown in FIG. 7, steps 92, 94, and/or 96 may follow step 212.

Following the monitoring in step 212 of the image data and in response to detecting the passenger 24 located in the passenger compartment 32, the controller 22 may begin a closing operation of the entry door 70 (214). After the controller 22 begins the closing operation, the controller 22 may monitor the angular position ϕ of the entry door 70 to determine if the door has reached a secondary latched position (216). If the entry door 70 is determined to have reached the secondary latched position, the controller 22 may activate a cinch motor to complete a closing operation of the entry door 70 and move the entry door into a primary latched position (218). If the door 14 does not reach the secondary latched position in step 216, the controller 22 may process steps 152-154 as previously discussed in reference to FIGS. 6A and 6B. Accordingly, the system 12 may be flexibly configured to operate based on one or more user inputs in response to the person 52 approaching the vehicle without any particular overt actions or inputs associated with the activation of the operation of the door control system 12.

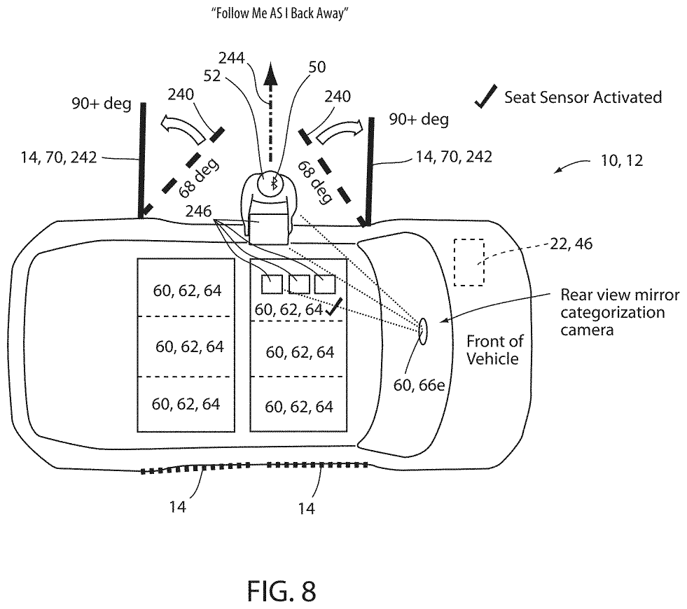

Referring now to FIG. 8, in some embodiments, the door control system 12 may be configured to control a plurality of the doors 14 concurrently or together to provide the person 52 with access to the passenger compartment 32 of the vehicle 10. As demonstrated in FIG. 8, two of the doors 14 may be associated and referred to as the entry doors 70. Accordingly, the entry doors 70 are demonstrated in a partially opened position 240 and a completely opened position 242. As demonstrated, the position of the entry doors 70 may have been previously controlled by one or more of the door opening and/or closing methods and underlying procedures as previously discussed herein. Accordingly, the example shown in FIG. 8 may focus on the operation of the door control system 12 in reference to the person 52 backing away from the vehicle 10 as demonstrated by the arrow 244.

In response to the detection of a package 246 or item positioned on one of the seats 64 as shown, the door control system 12 may detect the package 246 resting on the seat 64 based on one or more signals from an associated seat sensor 62. In this way, the door control system 12 may identify an interaction between the person 52 and the vehicle 10. The interaction between the person 52 and the vehicle 10 may also be identified based on the image data captured in the interior field of view 68e by the imager 66e. Following the detection of the interaction, the system 12 may detect the person 52 backing away from the vehicle 10 along arrow 244 based on a change in a position of the wireless communication signal from the mobile device 50 and/or a detection of the person 52 moving away from the vehicle 10 via the image data captured in the interior field of view 68e. Though discussed in reference to the interior field of view 68e, it may be understood that the fields of view 68a-68d of the imagers 66a-66d may similarly be monitored to detect the person 52 moving away from the vehicle 10.

In response to the person 52 moving away from the vehicle 10, the controller 22 may control the actuator 28 to open the doors from the partially opened position 240 to the fully opened position 242. Accordingly, the door control system 12 may control the angular position ϕ of the entry doors 70 to withdraw away from the person 52 such that the person 52 may easily withdraw and move away from the vehicle 10. In some embodiments, the controller 22 may monitor one or more signals from the interference sensor 36 (e.g. one or more signals from proximity sensors) to open and move away from the person 52 or maintain a predefined separation between the person 52 and an interior surface of the entry doors 70. In this way, the system 12 may provide for an intuitive control of the doors 14 such that the doors 14 are moved from a path of the person 52.

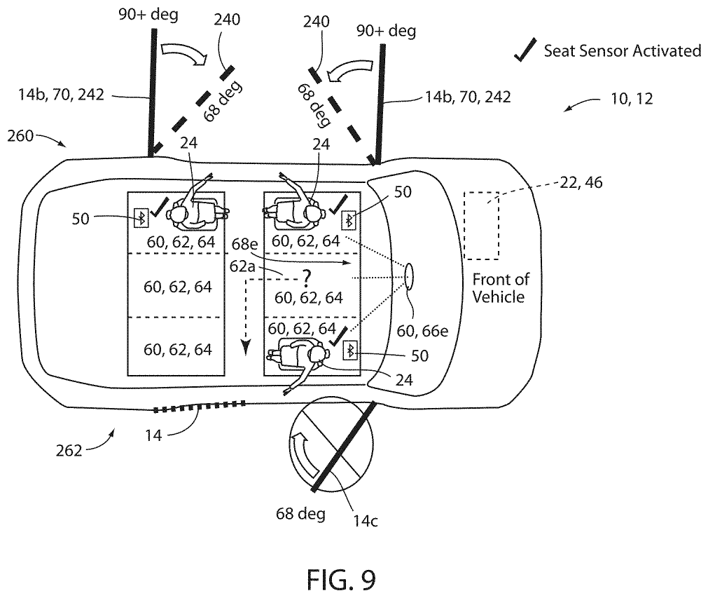

Referring now to FIG. 9, the door control system 12 may adjust or alter in operation based on changes in weight detected by the sensors 62 incorporated in the seats 64. For example, as demonstrated in FIG. 9, on a first side 260 of the vehicle 10, a plurality of passengers 24 are shown initiating a door control routine (e.g. steps 110-116). As illustrated, the system 12 has detected the passengers 24 in their respective seats 64 based on signals from the imager 66e, seat sensor 62, seatbelt/restraint sensors, and/or the communication signal from the mobile device 50. Accordingly, in response to the request to initiate a door-closing operation, the control system 12 may respond by closing or controlling the actuator 28 to adjust the angular position ϕ of each of the doors 14a, 14b to close from the completely opened position 242 to the partially opened position 240. From the partially opened position 240, the passengers 24 may manually close the doors 14a and 14b on the first side 260 of the vehicle 10 or the doors 14a and 14b may automatically close based on a desired operation of the system 12.

In some implementations, the control system 12 may be configured to restrict or limit operation of one or more of the doors 14 (e.g. 14c) in response to a change in the position of the communication signal from the mobile device 50 and/or a change in the weight or pressure detected by the seat sensor 62 of the seat 64. As demonstrated in FIG. 9, the door control system 12 is shown identifying a change in weight identified by a seat sensor 62a and a corresponding motion of an object which may be detected via the image data captured in the interior field of view 68e and/or motion of the communication signal from the mobile device 50. As shown, the detected motion in the vehicle 10 is identified moving from a central portion toward the second side 262. Accordingly, the door control system 12 may halt assisted or automated operations of the door 14c based on the assessment that an object may be moving toward the door 14c on the second side 262 of the vehicle 10. In this way, the system 12 may be configured to prevent unfavorable or unexpected operation of each of the doors 14.

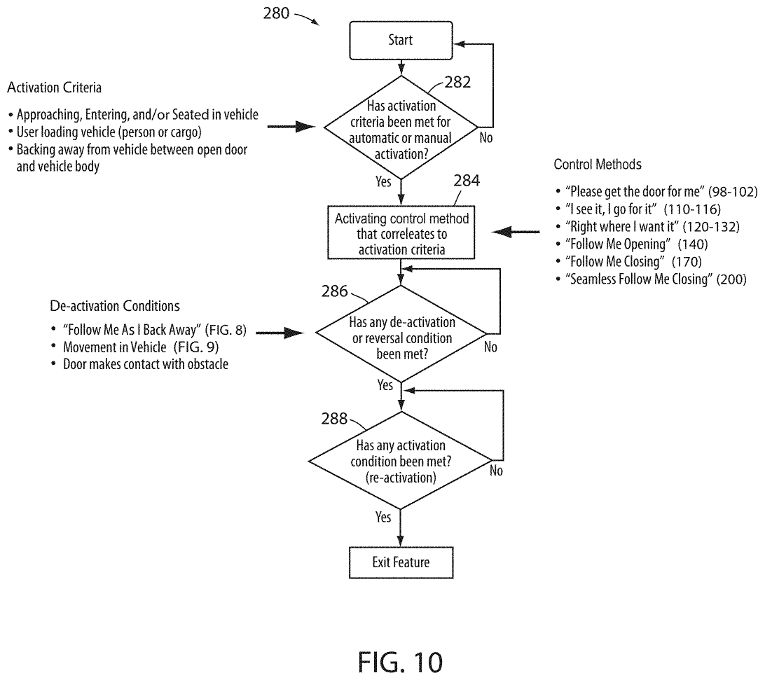

Referring now to FIG. 10, an overview of the operation of various implementations of the door control system 12 is discussed in reference to a flowchart. In general, a method 280 of operation of door control system 12 may begin by determining whether an activation criteria has been met for automatic or manual activation of the system (282). The various examples discussed in this application include, but are not limited to, instances where the person 52 is detected as approaching, entering, and taking a seated position in the passenger compartment 32, the person 52 being detected loading the package 246 or item into the passenger compartment 32, and/or the person 52 backing away from the vehicle 10 between an opened entry door 70 and the body of the vehicle 10. In response to the activation of the system in step 282, the door control system 12 may activate one or more of the control methods discussed herein in step 284. As previously discussed, each of the control methods may be activated in response to a user interaction with various interior or exterior handles, switches, touchscreen displays, or detection devices 60 of the vehicle 10. Additionally, the activation may be detected based on various gestures, detections of objects, or the person 52 via proximity sensors (e.g. the interference sensor 36), and/or a detection of the communication signal and the corresponding location of the mobile device 50 as identified by the communication circuit 46. As shown in FIG. 10, the reference numerals for the control methods are summarized as introduced in the description. For example, the control methods may comprise the following: “Please get the door for me” (98-102); “I see it, I go for it” (110-116); “Right where I want it” (120-132); “Follow Me Opening” (140); “Follow Me Closing” (170); and/or “Seamless Follow Me Closing” (200).

Once the activation criteria is identified in step 84, the system 12 may continue to step 286 to determine if any deactivation or door motion reversal conditions are met in step 286. Examples of door motion reversal conditions may include, but are not limited to, the detection of an object or obstruction by the interference sensor 36, a detection of the communication signal from the mobile device 50 in the swing path 38 of one or more of the doors 14, and/or the detection of an object or the person 52 via one or more of the imagers 66a-66e of the imaging system 66. Exemplary deactivation or door motion reversal conditions were previously discussed as “Follow Me As I Back Away” (FIG. 8); Movement in Vehicle (FIG. 9); and/or Door makes contact with obstacle. Following the detection of a deactivation or reversal condition, the system 12 may continue to identify whether a reactivation or activation condition for one or more of the door position control routines has been met (288). Following the detection of the activation or reactivation condition, the system 12 may complete the door control routine and monitor the various sensors and inputs discussed herein to control later routines for the doors 14 of the vehicle 10.

For the purposes of describing and defining the present teachings, it is noted that the terms “substantially” and “approximately” are utilized herein to represent the inherent degree of uncertainty that may be attributed to any quantitative comparison, value, measurement, or other representation. The term “substantially” and “approximately” are also utilized herein to represent the degree by which a quantitative representation may vary from a stated reference without resulting in a change in the basic function of the subject matter at issue.

It will be understood that any described processes or steps within described processes may be combined with other disclosed processes or steps to form structures within the scope of the present disclosure. The exemplary structures and processes disclosed herein are for illustrative purposes and are not to be construed as limiting. It also is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A power door system for a vehicle comprising:
an actuator configured to control a position of a door about a hinge assembly;
a plurality of detection devices configured to detect an approaching passenger of the vehicle and to detect a seated passenger within a passenger compartment of the vehicle;
an angular position sensor configured to identify an angular position of the door; and
a controller configured to:
control the actuator to position the door in a first opened position in response to the detection of the approaching passenger; and
control the actuator to control the door to a second opened position in response to detecting the seated passenger in the passenger compartment.

2. The system according to claim 1, wherein the door is oriented at a first angle in the first opened position and a second angle in the second opened position, wherein the second opened position is less than the first opened position.

3. The system according to claim 2, wherein the second angle is configured to position the door such that a handle of the door is within a predetermined distance of the passenger compartment of the vehicle.

4. The system according to claim 3, wherein the predetermined distance is a reach distance measured from a passenger seat of the vehicle to the handle of the door.

5. The system according to claim 1, wherein the first opened position comprises the angular position of the door at an angle greater than or equal to 70 degrees.

6. The system according to claim 1, wherein the second opened position comprises the angular position of the door at an angle less than 70 degrees.

7. The system according to claim 1, wherein the plurality of detection devices comprises at least one imager or camera and a seat sensor.

8. The system according to claim 7, wherein the controller is further configured to:
identify the approaching passenger based on image data captured by the imager.

9. The system according to claim 7, wherein the controller is further configured to:
identify the seated passenger within the passenger compartment of the vehicle in response to a signal from the seat sensor.

10. The system according to claim 1, wherein the plurality of detection devices comprises a communication circuit configured to detect an approximate location of a mobile device via a communication signal.

11. The system according to claim 10, wherein the mobile device comprises at least one of a smartphone, a key fob, and a personal identification device.

12. The system according to claim 10, wherein the communication signal is communicated via a Bluetooth® low energy (BLE) communication protocol.

13. A method for controlling a power door system for a vehicle, the method comprising:
identifying an approaching passenger;
opening a door of the vehicle via an actuator to a first position in response to the detection of the approaching passenger;
detecting the approaching passenger in a passenger compartment of the vehicle as a seated passenger;
positioning the door of the vehicle at a second position in response to the detection of the seated passenger; and
awaiting a manual interaction with the door in the second angular position.

14. The method according to claim 13, further comprising:
identifying the approaching passenger based on image data captured by an imager.

15. The method according to claim 13, further comprising:
identifying the seated passenger within the passenger compartment of the vehicle in response to a signal from a seat sensor of the vehicle.

16. The method according to claim 13, wherein the door is positioned at a first angle in the first position and a second angle in the second position and the second angle is less than the first angle.

17. The method according to claim 16, wherein the first angle and the second angle are greater than 30 degrees.

18. The method according to claim 13, further comprising:
monitoring an acceleration rate of the door when opening the door; and
controlling the actuator to stop a motion of the door in response to the acceleration exceeding a predetermined threshold.

19. A power door system for a vehicle comprising:
an actuator configured to control a position of a door about a hinge assembly;
a plurality of detection devices comprising at least one imager and a seat sensor, wherein the imager is configured to detect an approaching passenger of the vehicle and the seat sensor is configured to detect a seated passenger within a passenger compartment of the vehicle;
an angular position sensor configured to identify an angular position of the door; and
a controller configured to:
identify the approaching passenger based on image data captured by the at least one imager;
control the actuator to position the door in a first opened position in response to the detection of the approaching passenger;
identify the seated passenger within the passenger compartment of the vehicle in response to a signal from the seat sensor; and
control the actuator to control the door to a second opened position in response to detecting the seated passenger in the passenger compartment.

20. The system according to claim 1, wherein the controller is further configured to:
detect the seated passenger reaching for the door based on the image data from the at least one imager; and
control the actuator to position the door in the second position in response to the detection of the seated passenger in combination with the detection of the seated passenger reaching toward the door.
